(19) United States
(12) Patent Application Publication
(10) Pub. No.: US 2009/0113155 A1
(43) Pub. Date: Apr. 30, 2009

(54) HARDWARE ANTI-PIRACY VIA NONVOLATILE MEMORY DEVICES

(75) Inventor: William Michael Beals, Englewood, CO (US)

Correspondence Address: EchoStar Technologies, L.L.C., c/o Dorsey & Whitney LLP, 370 Seventeenth St, Suite 4700, Denver, CO, 80202, US

(73) Assignee: EchoStar Technologies Corporation, Englewood, CO (US)

(21) Appl. No.: 11/932,359

(22) Filed: Oct. 31, 2007

(51) Int. Cl. G06F 12/14

(52) U.S. Cl. 711/164; 711/E12.091

(57) ABSTRACT

One embodiment of the present disclosure may take the form of protected or safeguard memory, such as a nonvolatile memory device. In operation, the nonvolatile memory device may not perform a command operation, such as a read operation, on locked password-protected sectors of a primary memory array. Once a password is provided to the nonvolatile memory device (for example, from or via an associated electronic device), the nonvolatile memory device may unlock the password-protected sectors.

### INTRODUCTION

The various embodiments described herein generally relate to nonvolatile memory devices and, more particularly, to nonvolatile memory devices having anti-piracy protection.

### BACKGROUND

A nonvolatile memory device may be electrically, magnetically or otherwise erased and reprogrammed, and may retain its memory if power is removed. Nonvolatile memory devices may be used to store and transfer data between computers and/or other digital products. More specifically, nonvolatile memory devices may be used in any number of electronic devices that store and/or transfer data, such as USB flash drives (e.g. memory sticks, flash sticks, handy drives, thumb drives, and jump drives), memory cards, set-top boxes, digital video recorders, and so on. As the popularity of nonvolatile memory devices increase, users' needs also increase for security or anti-piracy features to protect the data stored therein.

### SUMMARY

One embodiment of the present disclosure may take the form of protected or safeguard memory, such as a nonvolatile memory device. In operation, the nonvolatile memory device may not perform a command operation, such as a read operation, on locked password-protected sectors of a primary memory array. Once a password is provided to the nonvolatile memory device (for example, from or via an associated electronic device), the nonvolatile memory device may unlock the password-protected sectors.

More specifically, the nonvolatile memory device may prohibit a command operation, such as a read, write, or erase operation, from being conducted on any or all sectors within the memory array, except boot sectors, while the nonvolatile memory device is in password-protection mode. Sectors containing boot data may be the only sectors that are not password-protected in a primary memory array. The data in the boot sectors may allow a central processing unit (CPU), associated with the electronic device that utilizes the nonvolatile memory device, to perform boot-up operations, and perform certain checks (such as security checks). If the security checks pass, the CPU or another element of the electronic device, such a storage element, outputs a unique password to the nonvolatile memory device to unlock the password-protected sectors.

As will be realized by those of ordinary skill in the art upon reading the entirety of this disclosure, various embodiments of the invention are capable of modifications in various aspects, all without departing from the spirit and scope of the present invention disclosed herein. Accordingly, the drawings and detailed description are to be regarded as illustrative in nature and not restrictive.

### BRIEF DESCRIPTION OF THE DRAWINGS

The drawings described herein are for illustration purposes only and are not intended to limit the scope of the present disclosure in any way.

FIG. 1 depicts an exemplary environmental view for an exemplary nonvolatile memory device.

FIG. 2 is a block diagram of the exemplary nonvolatile memory device of FIG. 1.

FIG. 3 is a first exemplary flow chart illustrating a first operation of the nonvolatile memory device in FIG. 2.

FIG. 4 is a second exemplary flow chart of a second operation of the nonvolatile memory device in FIG. 2.

### DETAILED DESCRIPTION

One embodiment of the present disclosure may take the form of protected or safeguard memory, such as a nonvolatile memory device. In operation, the nonvolatile memory device may prevent access to data stored in locked password-protected sectors of a primary array. For example, the nonvolatile memory device may not perform a command operation, such as a read operation, on locked password-protected sectors of a primary memory array. Once a password is provided to the nonvolatile memory device (for example, from or via an associated electronic device), the nonvolatile memory device may unlock the password-protected sectors to allow access to data stored within those sectors. More specifically, the nonvolatile memory device may prohibit a command operation, such as a read, write, or erase operation, from being conducted on any or all sectors within the memory array, except boot sectors, while the nonvolatile memory device is in password-protection mode. Sectors containing boot data may be the only sectors that are not password-protected in a primary memory array. The data in the boot sectors may allow a central processing unit (CPU), associated with an electronic device that utilizes the nonvolatile memory device, to perform boot-up operations and perform certain checks (such as security checks). If the security checks pass, the CPU or another element of the device, such a storage element, outputs a unique password to the nonvolatile memory device to unlock the password-protected sectors.

The password may be unique for each specific nonvolatile memory device. If the nonvolatile memory device receives a request to read a password-protected sector that is locked, the nonvolatile memory device may ignore the request or output error data in lieu of data stored in a locked sector. Error data may include any data sent in response to a request for data located within a locked password-protected sector, other than the data actually contained therein. For example, the error data may include data from a non-password protected sector, such as data from boot sectors or secondary memory elements. This data may include random or meaningless data, a copy of boot sector data, a constant value, or general or specific error message data. Likewise, if an incorrect password is received, the nonvolatile memory device may output error data or ignore the request and wait for the next command to be received.

On the other hand, if the correct password is received, the nonvolatile memory device may unlock the password protected sectors. In the event that the electronic device or the nonvolatile memory device experiences a reset or power-up condition, the nonvolatile memory device may relock the password-protected sectors.

Generally, the password protection of the nonvolatile memory device increases the difficulty for an unauthorized user to erase or download the contents of the memory array. One reason for this is, prior to receiving the correct password, only the data stored in the boot sectors of the primary memory array are available to be read.

Additionally, the embodiment may provide nonvolatile memory device manufactures with the flexibility of manufacturing a single memory array layout for nonvolatile memory devices that includes designating the same sectors within a specific location as boot sectors for each nonvolatile memory device regardless of the electronic device that uses the nonvolatile memory device. This flexibility is accomplished by designing the primary memory array to include boot sectors, which are non-password protected sectors, and password-protected sectors that are locked up boot-up. With such a design, the nonvolatile memory device may output a copy of the data stored in the boot sectors, as error data, upon request for data stored in the locked password-protected sectors. This means that every sector within the memory array is effectively a boot sector until the correct password is received via the nonvolatile memory device.

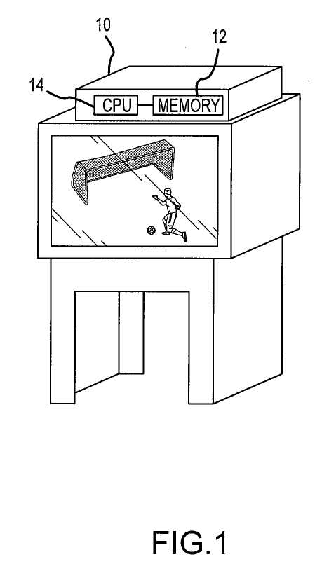

FIG. 1 depicts an exemplary environmental view for an exemplary nonvolatile memory device.

Referring to FIG. 1, an electronic device 10, such as a set-top box, may request stored data in a nonvolatile memory device 12 that may be an electronic holding place for instructions and other data for the electronic device's CPU 14. The nonvolatile memory device 12 may include any type of nonvolatile memory device, such as flash memory, read-only memory, magnetic computer storage devices (e.g. hard disks, floppy disk drives, and magnetic tape), and/or optical disc drives. Upon power up, the CPU 14 may request the retrieval of data stored in the nonvolatile memory device, such as operating instructions or data needed to continue a boot up operation for initial start up. After receiving initial boot-up instructions and/or data, the CPU 14 may output a unique password to the nonvolatile memory device. Afterwards, the CPU 14 may be granted access to data stored in password-protected sectors of the nonvolatile memory device.

The nonvolatile memory device 12 receives the requests from the CPU 14, or other elements within the electronic device 10, and accordingly responds. The nonvolatile memory device 12 may also receive the password, sent via the CPU 14, to unlock the password protected sectors. Afterwards, if the CPU 14 sends a command request to receive data stored in the nonvolatile memory device 12. The nonvolatile memory device 12 may receive the request and determine whether the data is stored in a locked password-protected sector. If so, the nonvolatile memory device 12 outputs error data to the CPU 14. If not, the nonvolatile memory device 12 outputs the data requested.

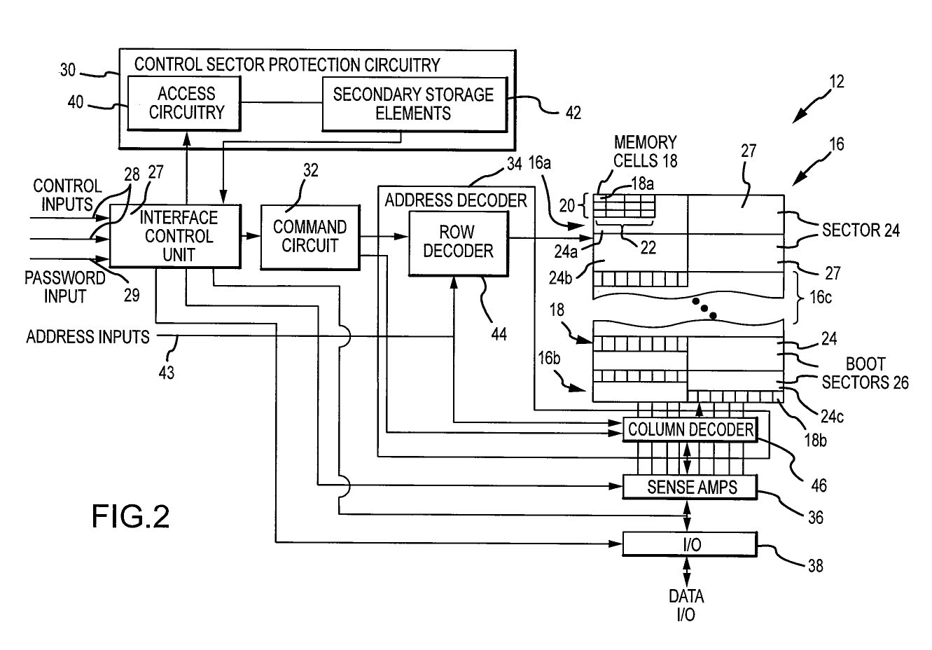

FIG. 2 is a block diagram of an exemplary nonvolatile memory device for use. Among other uses (such as in a computing device, audio and/or video player, mobile telecommunications device, and so forth), the exemplary nonvolatile memory device may be used in the set-top box of FIG. 1.

Now referring to FIG. 2, the nonvolatile memory device 12 may include one or more memory cells 18. Such cells may be arranged, for example, as a unit or array 16. In one embodiment, the array 16 may be arranged in a plurality of rows 20 and columns 22, such that each memory cell 18 may be located within a specific row and a specific column. The memory cells 18 in each row of the memory array 16 may be connected to a distinct row line. Additionally, the memory cells 18 in each row of the memory array 16 may be connected to a distinct column line. In an alternative embodiment, the array 16 may be arranged in a spiral fashion, such that the memory cell 18 may take the form of parallel tracks or stripes (e.g. curved or helical tracks).

The memory cells 18 may be grouped into a plurality of sectors 24 such that one or more memory cells 18 make up a single sector. A sector 24 is typically the smallest block, portion, or size of memory that may be operated upon. For example, a sector may be the smallest amount of memory that may be overwritten or erased. Sector sizes may vary, or alternatively, may be the same. Each sector may be a stand-alone entity, such that each sector may have functions performed on that sector without any conditions associated with or influencing neighboring sectors.

As shown in FIG. 2, the array 16 may also include a top portion 16a, a bottom portion 16b that may be located at an opposite end to the top portion 16a, and a middle portion 16c that extends between the top portion 16a and the bottom portion 16b. In such case, a first memory cell 18a, which has an address equivalent to a first row and a first column of a first sector of the array 16, is located within the top portion 16a, and a last memory cell 18b, which has an address equivalent to a last row and a last column of a last sector in the array 16, is located within the bottom portion 16b.

The array 16 may include at least one boot sector 26 programmed with data to facilitate the starting, initiation, or activation of the electronic device 10. The boot sector 26 may be located in the top portion 16a, the middle portion 16c, or the bottom portion 16b of the memory array 16. For example, the exemplary memory array 16 of FIG. 2 may include a plurality of boot sectors 26 located in the bottom portion 16b of the memory array 16. The data in the boot sectors 26 may allow the CPU 14 of the electronic device 10, which utilizes the nonvolatile memory device, to perform boot-up operations and perform certain checks (such as security checks). If the security checks pass, the CPU 14 or another element of the electronic device 10 may output a unique password to the nonvolatile memory device 12 to unlock the password-protected sectors 24a.

The array 16 may also include at least one non-boot sector 25 that is programmed with data or information that is not needed to boot the CPU 14 of an external electronic device 10, but may be needed to provide instructions and/or data to the electronic device 10 in communication with the nonvolatile memory device 12. These non-boot sectors 25 may be password protected until a unique password is provided to the nonvolatile memory device 12.

Still referring to FIG. 2, the nonvolatile memory device 12 may include an interface control unit 27. The interface control unit 27 may provide access between external devices and the nonvolatile memory device 12, as well as control sector protection circuitry 30, command circuits 32, an address decoder 34, sense amplifiers 36, and/or a data I/O circuit 38. The interface control unit 27 may receive commands and/or requests, from the electronic device 10, for performing memory access operations on the memory array 16 via control inputs 28. The commands and/or requests may include a read request for acquiring data from memory cells within a sector, an erase command for deleting any existing data within a sector, and/or a program or write command for writing data to a sector. In an alternative embodiment, such as an optical disk drive or other device which may include a pointer in a look up table that identifies where specific data resides, the erase command may reset the pointer to not point to the location of the specific data and/or delete any existing data from the memory cells. The interface control unit 27 may use such command and/or requests to initiate read, erase, and/or write operations.

The interface control unit 27 may also include a password input 29 for receiving a password to unlock password-protected sectors 24a in the memory array 16. While only one password input is shown, the interface control unit 27 may include a plurality of password inputs, such that each of the several password inputs may receive a portion of a single password, a different and distinct password or the entire password. If the interface control unit 27 receives a password from the CPU 14, or other element within the electronic device 10, it may determine if the password received is equal to an internally stored password. Alternatively, the password may be sent via a user of the electronic device 10. If the received password is equal to the internally stored password, the interface control unit 27 may unlock previously locked password-protected sectors 24a in order to allow a command operation, such as a read operation, to be performed on the password-protected sectors 24a.

On the other hand, if the interface control unit 27 determines that the received password is not equal to the stored password, the interface control unit 27 may prevent access to data written in locked password-protected sectors 24a. Additionally, in response to receiving an incorrect password, the interface control unit 27 may ignore the request or command or output error data. Error data may include any data sent in response to a request to access data located within a locked password-protected sector, other than the data actually contained therein. For example, the error data may include a copy of data in a non-password protected sector in the array 16, such as a copy of the data from a boot sector 26, or a copy of data from secondary storage elements 42. More specifically, the error data may include random or meaningless data, such as all 1s, all 0s, or both 1s and 0s, general error message data, specific error message data, boot sector data, a copy of the last data requested, or a copy of any data stored with the interface control unit or the secondary storage elements.

If the interface control unit 27 receives a request regarding data stored in a locked password-protected sector 24a and has not received a password at all, the interface control unit 27 may prevent access to data written to locked password-protected sectors 24a. Additionally, in response to receiving the request for the data stored in the locked password-protected sector 24a without a password, the interface control unit 27 may output error data. Error data sent in response to a request for data in a locked password-protected sector 24a without a password may be the same error data sent in response to a request for data in a locked password-protected sector 24a with an incorrect password; otherwise, the two responses may have designated different error data for each response.

The internal password may be stored in the interface control unit 27 or the sector protection circuitry 30. The internal password may be stored in an irrevocably locked sector, such that the sector or memory cells within this sector may not be modified. Alternatively, the internal password may be stored in a revocably locked sector, such that the sector or memory cells within this sector may be modified upon command. The password may be invisible to the CPU 14. In other words, the interface control unit 27 may not grant a command request from the CPU 14, such as a read request, regarding a sector or memory cells that may store the internal password in order to protect the location of the password and the password itself.

Additionally, the internally stored password is often, but not necessarily, a unique password to the nonvolatile memory device 12 and may be preprogrammed. In other words, in certain embodiments, no two nonvolatile memory devices have the same password. Each password-protected sector 24a may utilize the same password to unlock all of the password-protected sectors 24a that are locked. Additionally, each of the password-protected sectors 24a may be consecutively or simultaneously unlocked. Alternatively, each password-protected sector (or a group of password-protected sectors) may require a unique password to be unlocked.

As shown in FIG. 2, the nonvolatile memory device 12 may include control sector protection circuitry 30 that is coupled to the interface control unit 27. The control sector protection circuitry 30 may include status data for sectors with the memory array 16 and may change the status data for a particular sector or group of specific sectors based on a command received via the interface control unit.

More specifically, the sector protection circuitry 30 may include access circuitry 40 and secondary storage elements 42 that are coupled to the access circuitry 40 and/or the interface control unit 27. The access circuitry 40 may execute commands for reading, programming, and erasing data stored within the secondary storage elements 42. The secondary storage elements 42 can be volatile or non-volatile. The secondary storage elements 42 may store information that identifies sectors that may prevent access to specific sectors for read, write, or erase operations and the status of those protections. For example, the secondary storage elements 42 may store the status of revocably lockable sectors, irrevocably locked sectors, and/or password-protected sectors 24a. Alternatively, the information that identifies the above-mentioned sectors may be password protected and the status of whether password-protection for a particular sector may be stored in a sector of the memory array 16, such as one of the boot sectors 26.

Revocably lockable sectors 24b may include sectors 24 that may be arbitrarily and independently unlocked and locked to prevent a write or erase operation from being performed on these sectors. Irrevocably lockable sectors 24c may include sectors 24 that may be permanently locked after the nonvolatile memory device 12 has been loaded within the electronic device 10, such that these sectors may not have an erase or write operation performed on them. In other words, once locked with a software command, the irrevocably lockable sectors 24c are permanently and irrevocably locked. Once the nonvolatile memory device 12 is associated with the electronic device 10, the irrevocably lockable sectors may not be erased or reprogrammed by any software command. Additionally, password-protected sectors 24a may include sectors 24 that may be locked in order to prevent access to these sectors until a correct password is provided via the CPU 14 of the electronic device 10. The status of each of the above-mentioned sectors 24 may be active or inactive, wherein the active status may indicated by “1” stored in a designated memory cell of the secondary storage elements 42 and the inactive status indicated by “0” stored in the memory cell of the secondary storage elements 42, or vice versa.

Some sectors 24 of the array 16 may have multiple status identifiers stored in the secondary storage elements 42. For example, a sector 24 may be revocably locked and password protected. In such case, a sector 24 may require a first correct password to allow a read operation performed on it. The first correct password may not allow a write or erase operation to be performed on the sector. Instead, a second password may be required to change the revocably locked status associated with the sector. Only if the second password is supplied is the sector unlocked for purposes of a write or erase operation.

Further, some sectors 24 may be both irrevocably locked and password protected. Such sectors may be allowed to have a read operation performed on them if the correct password is provided, but the sectors may never be allowed to have a modify operation, such as a write or erase operation, performed on them.

The nonvolatile memory device 12 may include command circuits 32 coupled to the interface control unit 27 and the address decoder 34. The command circuit 32 may typically receive a read or modify command from the interface control unit 27 and executes a corresponding operation. Thus, if a command is received, the command circuit 32 outputs a command signal to begin the process of the requested command and access the requested sectors.

Again referring to FIG. 2, the address decoder 34 will be further discussed now. The address decoder 34 may be coupled to external address inputs 43, the command circuit 32, the memory array 16, and the sense amplifiers 36. The address decoder 34 may receive an externally generated address and, in response, activates a row of memory cells and/or a column of memory cells in a sector 24. More specifically, the address decoder 34 may include row decoder circuitry 44 that, in response to receiving an externally generated address, drives a single row line corresponding to the externally generated address to a first voltage level in order to activate each memory cell 18 in the row, while driving the remaining row lines to another voltage level to deactivate the memory cells in the remaining rows.

The address decoder 34 may include the column decoder circuitry 46 that is connected to the external address inputs 43 and the column lines, of the memory cells, that correspond to the external generated address. The column decoder circuitry 46 receives the external address and, in response, selects one or more column lines corresponding to the externally generated address.

Referring to FIG. 2, the sense amplifiers 36 will be further discussed now. The sense amplifiers 36 may be coupled to the column decoder circuitry 46. The sense amplifiers 36 may sense the voltage levels on the column lines corresponding to the data stored in the addressed memory cells, and amplify the voltage levels such that they are read or otherwise handled by external circuitry.

Now, the data I/O 38 of the nonvolatile memory device 12 is further discussed. The data I/O circuit 38 may couple addressed memory cells to external I/O data pins. As shown in FIG. 2 of the exemplary embodiment, the data I/O circuit 38 may also be coupled to the sense amplifier 36 to output the amplified voltage levels to the I/O data pins.

During a read operation, the row decoder circuitry 44 receives external address information and selects corresponding row lines. The row decoder circuitry 44 also generates and outputs a voltage signal to the corresponding row lines to activate the row lines. Additionally, the column decoder circuitry 46 activates corresponding column lines, such that a voltage level may be sensed via the sense amplifiers 36 and outputted via the data I/O circuit 38.

If an erase operation is performed, the row decoder circuitry 44 activates the row lines as stated above. Additionally, the column decoder circuitry 46 activates the corresponding column lines of the corresponding external address and outputs a voltage signal to erase data stored in the specific columns and rows. Likewise, if a write operation is performed, all details remain the same, except the column decoder circuitry 46 outputs a voltage signal to write data stored in the specific columns and rows. When an erase or write operation for specific memory cells is performed, each cell 18 may also need a read operation to be performed on it in order to verify that the particular write or erase operation was correctly performed.

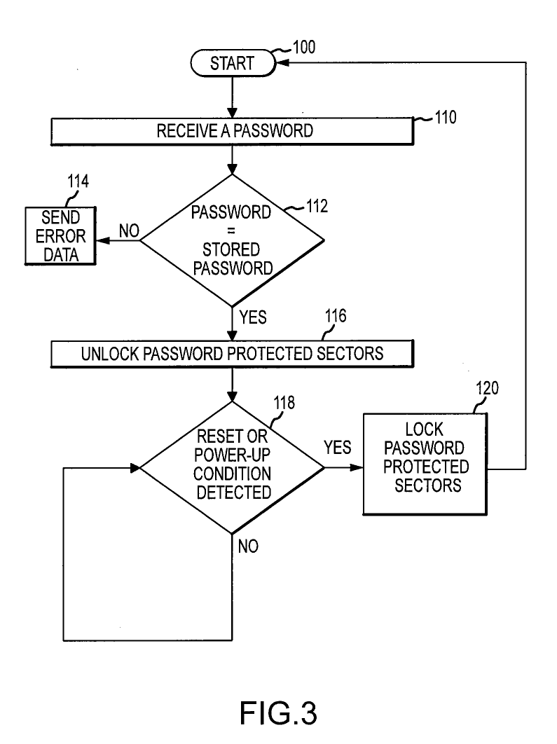

FIG. 3 is a first exemplary flow chart illustrating an exemplary boot-up sequence of the nonvolatile memory device 12 in FIG. 2. This operation presumes that the password has been stored within the nonvolatile memory device 12.

The sequence begins in start operation 100. In operation 110, the interface control unit 27 may receive a password, sent via the CPU 14 or other element of the electronic device 10, to unlock the locked password-protector sectors 24a. The interface control unit 27 retrieves an internally stored password from the secondary storage elements 42. In operation 112, the interface control unit 27 compares the received password to the stored password. If the received password is not equal to the stored password, operation 114 executes, and the interface control unit outputs error data to the electronic device 10.

If the password is equal to the stored password in operation 112, operation 116 is accessed. In operation 116, the interface control unit 27 unlocks the locked password-protected sectors 24a. In doing so, the interface control unit 27 may initiate an erase and/or write operation with the secondary storage elements 42 to change the status indicators of the password-protected, previously locked sectors.

In operation 118, the interface control unit 27 checks to determine if the electronic device 10 or the nonvolatile memory device 12 has experienced a reset or power up condition. If not, the interface control unit 27 continues to check for a power-cycle condition and/or a reset condition in operation 118. If so, operation 120 executes, and the interface control unit 27 relocks the password-protected sectors 24a. After relocking the password-protected sectors 24a, operation 100 executes to restart the sequence of operations to unlock the password-word protected sectors 24a.

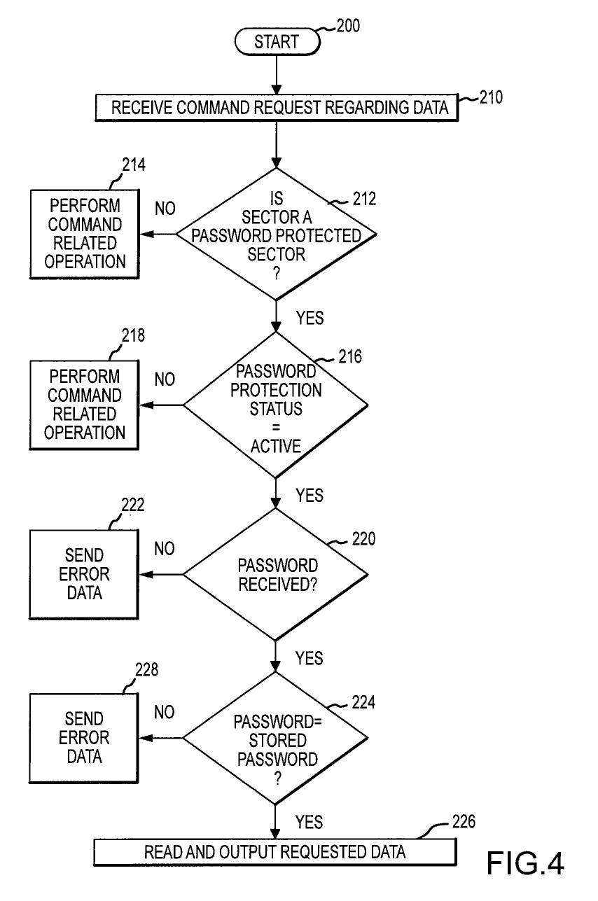

FIG. 4 is a second exemplary flow chart of a second operation of the nonvolatile memory device 12 in FIG. 2. This operation assumes that the nonvolatile memory device 12 has locked password-protected sectors 24a and boot sectors 26.

The sequence begins in start operation 200. In operation 210, the interface control unit 27 receives a read command for at least one sector of the primary memory array 16 for a specific address. The interface control unit 27 determines whether the sector 24 is a password-protected sector 24a in operation 212. In doing so, the interface control unit 27 outputs a read command and the address of the requested sector to the sector protection circuitry 30. The access circuitry 40 of the sector protection receives the address and initiates a read operation on the secondary storage elements 42 in order to determine whether the data requested is located within a password-protected sector 24a. Such data is sent to the interface control unit 27 to determine whether the requested sector is protected from execution of the operation. If not, operation 214 executes, and the interface control unit 27 initiates the read operation for the specified sector. If so, operation 216 executes, and the interface control unit 27 determines whether password protection for the specific sector is active. If the interface control unit 27 determines that the sector is unlocked in operation 216, operation 218 executes, and the interface control unit 27 initiates the read operation for the specified sector to output the requested data. However, if the interface control unit 27 determines in operation 216 that the password protection is active for the selected sector, in operation 220, the interface control unit 27 checks to determine whether a password has been received. If no password has been received, operation 222 executes, and the interface control unit 27 outputs error data.

The following sequence of operations may parallel some of the operations listed in FIG. 3, but are repeated herein in order to present to the reader an exemplary overview of the operations of the non-volatile memory array 16. Thus, if a password has been received in operation 220, operation 224 executes, and the interface control unit 27 compares the received password to the stored password. If the received password is equal to the stored password, operation 226 executes, and the interface control unit 27 initiates a read operation for the requested data and outputs the data to the CPU 14. On the other hand, if the received password is not equal to the stored password, operation 228 executes. In operation 228, the interface control unit 27 outputs error data to the electronic device 10.

While the implementation of the present embodiments is disclosed herein as a hardware implementation, the password protection features executed by the interface control unit and the sector protection circuitry may take of a software implementation that may be programmed in any appropriate computer-executable language.

Although the present invention has been described with reference to preferred embodiments, persons skilled in the art may recognize that changes may be made in form and detail without departing from the spirit and scope of the invention.

What is claimed is:

1. A nonvolatile memory device comprising:
an array of memory cells divided into a plurality of sectors including a first sector and a second sector, the first sector being protected to prevent access to data stored in the first sector until a password is received, the second sector storing data that is not protected via the password such that the data stored in the second sector may be accessed when requested.

2. The nonvolatile memory device of claim 2, further comprising:
an address decoder operatively coupled to the array, the address decoder is configured to receive an address from an external input and select a specific sector based on the address; and
an interface control unit operatively coupled to the array and the address decoder, the interface control unit is configured to prevent a command operation on the first sector unless the password is provided.

3. The nonvolatile memory device of claim 2, wherein the password is an external password received by the nonvolatile memory device.

4. The nonvolatile memory device of claim 2, wherein the second sector including boot data that allows an external electronic device to proceed with boot up operations.

5. The nonvolatile memory device of claim 2, wherein the interface control unit compares an internally stored password to the received password.

6. The nonvolatile memory device of claim 5, wherein the interface control unit is further configured to output error data when the received password does not match the internally stored password.

7. The nonvolatile memory device of claim 5, wherein the interface control unit is further configured to allow access to the data in the first sector when the received password is equal to the internally stored password.

8. A nonvolatile memory device comprising:
an array of memory cells divided into a plurality of sectors including a first sector and a second sector, the first sector being locked to prevent access to data stored in the first sector until a correct password is received, the second sector storing data that is unlocked to allow access to the data stored within the second sector;
an address decoder operatively coupled to the array, the address decoder is configured to receive an address from an external input and select a specific sector based on the address; and
an interface control unit operatively coupled to the array and the address decoder, the interface control unit is configured to unlock the first sector to allow access of an operation when the password, external to the nonvolatile memory device, is received, and, thereafter, outputs data stored in the first sector upon receipt of an external request.

9. The nonvolatile memory device of claim 8, wherein the interface control unit is further configured to output error data when a command request, to access data stored in the first sector, is received via the interface control unit, and the password has not been received.

10. The nonvolatile memory device of claim 9, wherein the interface control unit is further configured to output a copy of the data from the second sector as the error data, when the command request is received via the interface control unit and the password has not been received.

11. The nonvolatile memory device of claim 9, wherein the interface control unit is further configured to output a constant value as the error data, when the command request is received via the interface control unit and the password has not been received.

12. The nonvolatile memory device of claim 9, further comprises a second memory array including at least one memory cell that stores the error data.

13. The nonvolatile memory device of claim 8, wherein the interface control unit is further configured to determine whether the first sector has an active password-protection status.

14. The nonvolatile memory device of claim 8, wherein the interface control unit is further configured to modify a password-protection status of the first sector from active to inactive when the password is received.

15. The nonvolatile memory device of claim 1, wherein the first sector is a revocably locked sector that is locked temporally to prohibit a modify operation from being performed on that sector.

16. A method of using a nonvolatile memory device comprising:
receiving a first command request from an external source to access data in a first sector of a memory array of the nonvolatile memory device;
receiving an address for the first sector; and
preventing the first command request from being performed on the first sector unless a unique password, equal to a previously stored password located within the nonvolatile memory device, is received.

17. The method of claim 16, further comprising reading a second sector that is in the memory array of the nonvolatile memory when the password is not provided.

18. The method of claim 16, further comprising:
receiving the password, independent of a user input, from an associated electronic device; and
initiating the first command operation when the external password equals a stored password for the nonvolatile memory device.

19. The method of claim 16, further comprising:
unlocking the first sector, when the external password is received, to allow access to the data stored within the first sector; and
relocking the first sector when the nonvolatile memory device experiences a power reset or boot-up operation.

20. A nonvolatile memory device comprising:
an array of memory cells divided into a plurality of sectors including a first sector and a second sector, the first sector being protected to prevent access to data stored in the first sector until a password is received, the second sector storing data that is not protected via the password such that the data stored in the second sector may be accessed when requested;
an address decoder operatively coupled to the array, the address decoder is configured to receive an address from an external input and select a specific sector based on the address;
an interface control unit operatively coupled to the array and the address decoder, the interface control unit is configured to prevent a command operation on the first sector unless the password is provided;
wherein the second sector stores boot data that allows an external electronic device to proceed with boot up operations; and
wherein the interface control unit compares an internally stored password to the received password.

21. An apparatus for use in receiving an audio signal, video signal, data signal, or any combination thereof, comprising:
a receiving device, wherein the receiving device receives at least one of an audio signal, a video signal, a data signal or a combination audio, video and/or data signal; and
a memory device, coupled to the receiving device, further comprising:
an array of memory cells divided into a plurality of sectors including a first sector and a second sector, the first sector being protected to prevent access to data stored in the first sector until a password is received, the second sector stores data that is not protected via the password such that the data stored in the second sector may be accessed when requested.
